(19) United States
(12) Patent Application Publication
(10) Pub. No.: US 2002/0156994 A1
(43) Pub. Date: Oct. 24, 2002

(54) Coprocessor architecture for control processors using synchronous logic

(76) Inventors: Sanjay Agarwal, Santa Clara, CA (US); Sapna Agrawal, Santa Clara, CA (US)

Correspondence Address: Sanjay Agarwal, CHIPSOL, Inc., 4702 Cheeney St., Santa Clara, CA, 95054, US

(21) Appl. No.: 09/841,536

(22) Filed: Apr. 24, 2001

(51) Int. Cl. G06F 15/00

(52) U.S. Cl. 712/35; 712/221

(57) ABSTRACT

A method for implementing coprocessors for control processors uses synchronous logic design method to achieve low cost and high performance in control processors. The coprocessor comprising of signed two's complement multiplication, signed divide, shift left and shift right, and normalization comprises of most of the math functions required for implementing digital signal processing algorithms. The processor coprocessor architecture uses data dependency to compute the time duration required to perform the math computation. This results in efficient implementation of DSP algorithms and eventually translates to better system level performance. The technique described to implement math computations uses a register file interface, existing instruction set, and existing legacy software development infrastructure to implement DSP systems.

### CROSS-REFERENCE TO RELATED APPLICATIONS

Not Applicable.

### STATEMENT REGARDING FEDERALLY SPONSORED RESEARCH AND DEVELOPMENT

Not Applicable.

### SEQUENCE LISTING

Not applicable.

### REFERENCE TO A MICROFICHE APPENDIX

Not Applicable.

### FIELD OF THE INVENTION

This invention relates to the field of computer architecture. In particular, this invention relates to the design of math coprocessor architecture for use in conjunction with a general purpose control processor to provide Digital Signal Processing (DSP) capabilities in control processor environment.

### BACKGROUND OF THE INVENTION

DSP is widely used in the industry to solve industry problems like noise filtering and processing of industrial control data for the purpose of monitoring and analysis. The progress in the area of audio and video technology requires greater information processing capability in real time systems. This requirement compels integrated circuits to provide math intensive and math capable logic design. Integrated circuits capable of performing math operations also find widespread use in embedded applications like telecommunications, wireless, facsimile transmissions, data networks, and storage area networks. Telephony applications are examples of telecommunications applications that demand an increasing amount of math capability for efficient implementation of DSP algorithms. DSP algorithm techniques are also being widely used in internet appliance industry that use integrated circuits for data input and data output.

DSP is primarily concerned with implementing error correction, filtering, compression, and quantization of incoming and outgoing data streams. Speed of computation is the primary area of concern for computer architects who design the control processors. The speed requirements are dependent on the application and the time available for doing the computation. For applications involving real time transfers of audio and video data, the time available is the least. In this situation a powerful digital signal processor working at high speed is used. On the other extreme, applications like industrial process controllers, storage networks, and some internet appliances have some finite amount of time to handle the DSP functions. The data generated by the control processors for analysis or data being transmitted for storage is not required to be available on real time basis.

DSP functions are math intensive algorithms that require specialized math circuitry to effectively perform math computations. Prior art methods for accomplishing mathematical functions in industrial processors include (1) using the primary processor instructions for doing DSP, or (2) using a coprocessor together with primary processor.

Using the host processor to perform the math intensive computation is not an efficient utilization of computing resources. The general purpose control processor typically does not support math capabilities required by DSP algorithms. The control processor for industrial environment is designed to handle a large number of input and output operations. These control processors are normally designed with simple arithmetic and logic unit that can support simple arithmetic and logic operations.

Another disadvantage of using the control processor to perform math operations is that the control processor may not be designed to handle data widths larger than its own data path width. Performing higher bit width computations with lower bit width data path within the control processor architecture makes the operations within the control processor very inefficient. This adversely impacts the overall performance of the control processor system.

The technique to improve control processor performance and provide circuitry for math intensive computations would be to build a coprocessor which can be used to offload part of the processing demands from the control processor. In particular, a numeric coprocessor can be integrated with control processor to enhance system performance when performing DSP algorithms.

Numeric processors are designed to reduce the burden on the control processor system for executing math computing functions. The system performance with respect to handling math computations is significantly improved using such controller architecture. Examples of prior art numeric coprocessors include 8087, 80287, and 80387DX numeric coprocessors manufactured by Intel Corporation of Santa Clara, Calif. These numeric coprocessors are specifically designed to perform high-speed math computations at a rate greater than the counterpart host processor. As progress was made in the process technology, the numeric coprocessor was incorporated into the host processor function. The emphasis on the numeric coprocessor was interface. Prior art numeric coprocessors, such as Intel 80387DX, are tightly integrated with the host microprocessor. The tight integration is achieved by coupling numeric coprocessor interface with the host processor. The host processor is responsible for all instruction fetch intended for host processor and numeric coprocessor. Whenever the host processor fetches an instruction for numeric coprocessor, it automatically passes the instruction to numeric coprocessor.

One of the disadvantages of very specific or tight coupling between host processor and numeric processor is that the functionality is very strict. The interface is very specific to the numeric coprocessor and the system comprising of host processor and numeric processor can execute a fixed library of math functions.

Another disadvantage of using new instructions for performing math functions in numeric coprocessor is that an entirely new compiler or assembler is required when using numeric coprocessor instructions as compared to using the legacy compilers and assemblers for the host processor.

Using new numeric coprocessor instructions also involves learning new instructions by system designers. This can be a significant investment for the purpose of doing product development. Several processor-coprocessor architectures have been created in the past. A very generic representation of processor-coprocessor architecture is as shown in FIG. 1. Some implementations of coprocessor also enable floating-point arithmetic operations. The coprocessor in most cases executes instructions dispatched from the Central Processing Unit (CPU) (Kai Hwang, Advanced Computer Architecture—Parallelism, Scalability, Programmability, McGraw-Hill Inc, 1993, at pages 161-162, which is hereby incorporated by reference). The table in FIG. 2 lists some processor-coprocessor pairs developed in recent years to speed up numerical computations.

Inventors have created several system designs and solutions to achieve processor-coprocessor design in computer systems. Some of the methods and apparatus are as follows:

The coprocessor can be implemented to perform a wide variety of mathematical functions. U.S. Pat. No. 5,764,939 (1998) titled “RISC Processor having coprocessor for executing circular mask instruction” assigned to Robert L. Caulk, Jr., describes a technique to achieve the circular mask function. In this technique, the processor operates on the value stored in the general register with the value in the immediate field and then masks the result using the circular mask value. The operation also includes sign extending the immediate field before adding to the contents of the general register to provide a sum. The coprocessor can be designed to provide a wide variety of mathematical capability depending on the system application. Many times, the function designed in the coprocessor is specifically targeted to simplify a DSP algorithm. The block diagram for this architecture is as indicated in FIG. 3. This technique of implementing coprocessors with very specific math function may not be applicable in a wide variety of other DSP applications.

U.S. Pat. No. 5,768,553 (1998) titled “Microprocessor using an instruction field to define DSP instructions” assigned to Thang M. Tran, describes a technique that defines fields in the instructions to specify the DSP instruction. The instruction decode unit in this invention is configured to detect an instruction field included within an instruction and to dispatch instructions having the instruction field to the DSP unit. The DSP unit then performs the DSP operation, such as a multiply-accumulate function. The block diagram for this architecture is as shown in FIG. 4. The disadvantage of this technique is that it involves modifications to the instruction decode section of the host processor to recognize DSP instructions and dispatch them to DSP unit. This requires design of special units in the host processor system.

U.S. Pat. No. 4,870,614 (1989) titled “Programmable Controller (“PC”) with co-processing architecture” assigned to Jesse T. Quatse describes a programmable controller architecture utilizing specialized processors in a co-processing system so that each function is optimized. The system described contains first and second processors having respective associated means of fetching instructions from a common memory. Each of the processors and its instruction set is tailored to a corresponding processor's specialized function. Each processor in this invention monitors the instructions to be executed. Upon occurrence of instruction for which a particular processor is tailored, the particular processor executes that instruction. The block diagram for this architecture is as shown in FIG. 5. This invention describes an implementation by which a variant coprocessor is designed and each processor in the system does decoding of the instructions to be executed. This method of implementation is very expensive because of replication of decode function and also because each of the processors will have direct access to the instruction memory unit of the system.

U.S. Pat. No. 5,742,839 (1998) titled “Coprocessor for performing an arithmetic operation by automatically reading data from an external memory” assigned to Suetake et al. describes a technique to enhance the speed performance of arithmetic operations. In this technique the sequence of commands to be executed is transferred from external memory to high-speed accessible memory provided in the microprocessor. This scheme is a description of how commands to be executed can be pre-fetched into a high speed memory as a mechanism to speed up execution by the main processor. This scheme involves design of command storage unit within the microprocessor. This scheme involves acceleration of existing commands but does not add to any functionality of the processor architecture. The block diagram for this architecture is as shown in FIG. 6.

U.S. Pat. No. 5,809,320 (1998) titled “High-performance multi-processor having floating point unit” assigned to Jain et al. contains a description of a pipelined CPU which executes instructions of variable length, and referencing memory using various data widths. The patent describes macro-instruction pipelining with queuing between units of CPU to allow flexibility in instruction execution times. The technique described in this patent uses multiple processors to speed up execution of instructions. The block diagram of FIG. 7 shows the details of this technique. This patent shows multi-processor implementation of doing floating point arithmetic.

U.S. Pat. No. 5,574,933 (1996) titled “Task flow computer architecture” assigned to Robert W. Horst describes an architecture that has multiple processing cells that are interconnected for program execution. Each execution unit is provided with memory and instruction processing elements. Each instruction packet comprises of instruction, data, and a pointer to the next memory packet. The processing cells execute tasks in parallel to achieve speed performance. This scheme uses technique similar to multi-processing to achieve higher bandwidth in instruction execution. The block diagram for this architecture is as described in FIG. 8.

Another implementation of on-chip arithmetic is described in Siemens Microcontroller handbook for product SAB 80C517 (Microcontroller Handbook, SIEMENS On-Chip Peripheral Component, pages 126-133, which is hereby incorporated by reference). This architecture describes an implementation for 32-bit division, 16-bit multiplication, as well as shift and normalize functions. The implementation describes all operations to be in unsigned integer operations. The math unit comprises of seven registers that act as interface to the math unit. The selection of the operation to be performed is done by the order in which writes happen to the registers. The order of writing and reading to the registers is important to select and read the correct math operation. The sequence of writing and reading is as described in FIG. 9. Each of the math operations also requires a pre-determined amount of time for correct execution. The system designer is expected to keep track of the elapsed time before attempting to fetch back the results. The elapsed time table is as shown in FIG. 10. The other control functions for the math operations are provided in the form of a control register. The block diagram of the control register is as shown in FIG. 11.

The processor coprocessor architectures of prior art focus on implementing complex design techniques. Techniques like implementing a separate decode unit to decode DSP instructions or to provide separate instruction fetch logic is expensive in terms of design implementation. Enhancing the instruction set requires design changes to the implemented silicon. Adding new instructions also requires changes to the software development tools in the form of compiler and assembler changes. Some prior art techniques also describe multi-processing as an option to improve execution times in processors. Multi-processing techniques involve complex circuit design methods. Multi-tasking systems also need sophisticated software design tools to be able to benefit from multi-processing capable systems. In other techniques of prior art, selecting the math operation based on the sequence of writing to the registers places overhead on the software designers and the process can be erratic. Also, implementing time loops or waiting for finite time after starting the math computation can degrade system performance.

The processor coprocessor design can be optimized for cost and performance if we use the existing instruction set and design the coprocessor using synchronous logic. This technique will result in lower cost for the overall system design. The lower cost will be achieved by using optimal number of gates and using optimal amount of time for math computation.

### BRIEF SUMMARY OF THE INVENTION

The present invention provides integrated circuit logic design and architecture for control processors. The math logic unit or the DSP engine comprises of 16-bit by 16-bit signed two's complement multiplication unit, 32-bit by 16-bit signed division unit, 32-bit shift left and shift right unit, and 32-bit normalization unit implemented using synchronous logic. The DSP engine is designed as a peripheral block for the host control processor. Other math computations can be added into another peripheral should the application need that computation. No new instructions are added to achieve DSP capability. The architecture uses string based math computations so that the time required to do the math computation is dependent on the logic 0's and logic 1's of the operands. The architecture uses the existing instruction set to achieve the math computation capability.

### BRIEF DESCRIPTION OF THE SEVERAL VIEWS OF THE DRAWING

The features believed to be characteristic of this invention are set forth in the appended claims. The invention itself however, as well as further objects and advantages thereof, will best be understood by reference to the following detailed description of an illustrative embodiment, when read in conjunction with the accompanying drawings, wherein:

FIG. 1 is prior art and is a generic block diagram of processor coprocessor system.

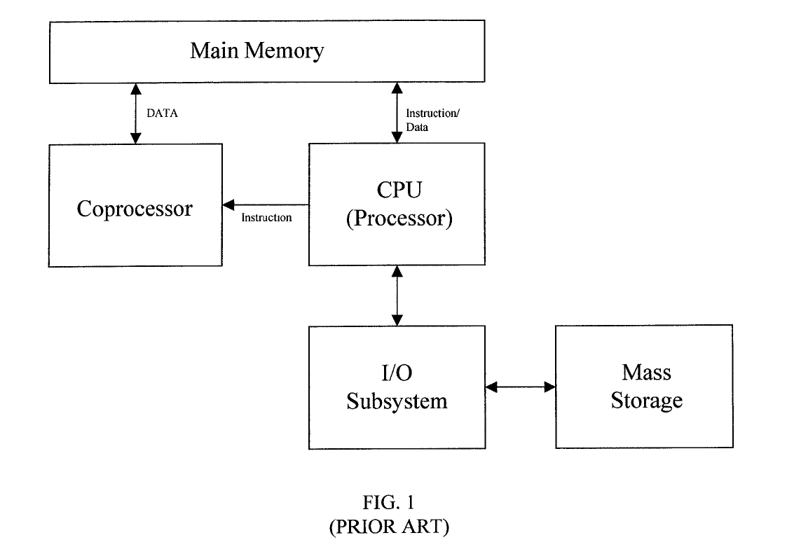

FIG. 2 is prior art and is a table of processor-coprocessor pairs.

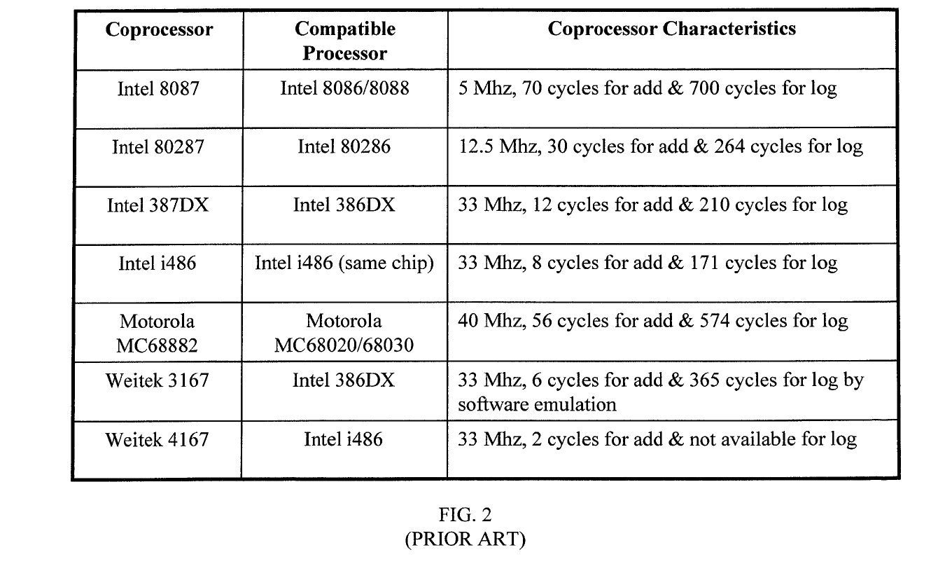

FIG. 3 is prior art and is an architectural block diagram for RISC processor for executing circular mask function.

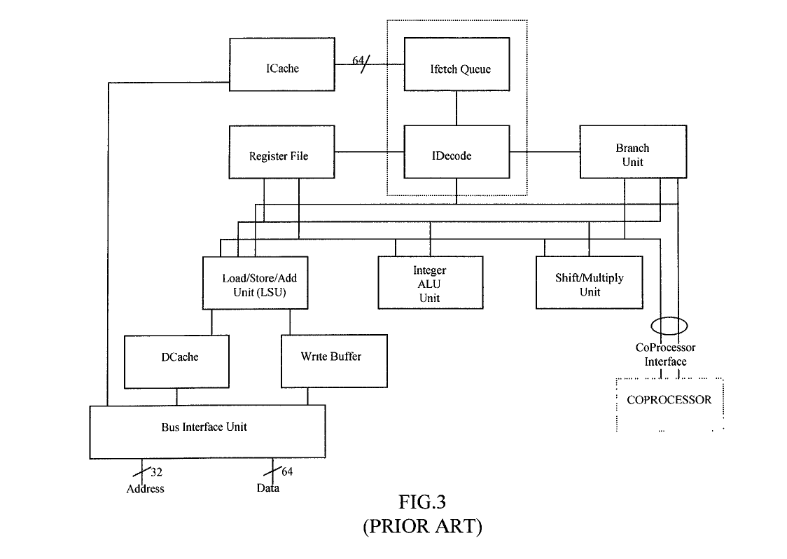

FIG. 4 is prior art and is an architectural block diagram for Microprocessor using an instruction field to define DSP instructions.

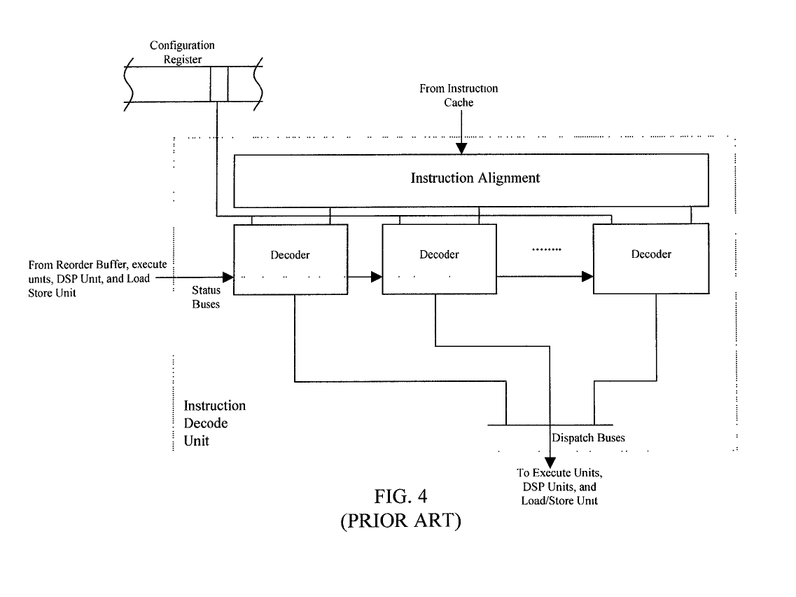

FIG. 5 is prior art and is a block diagram for Programmable Controller with co-processing architecture.

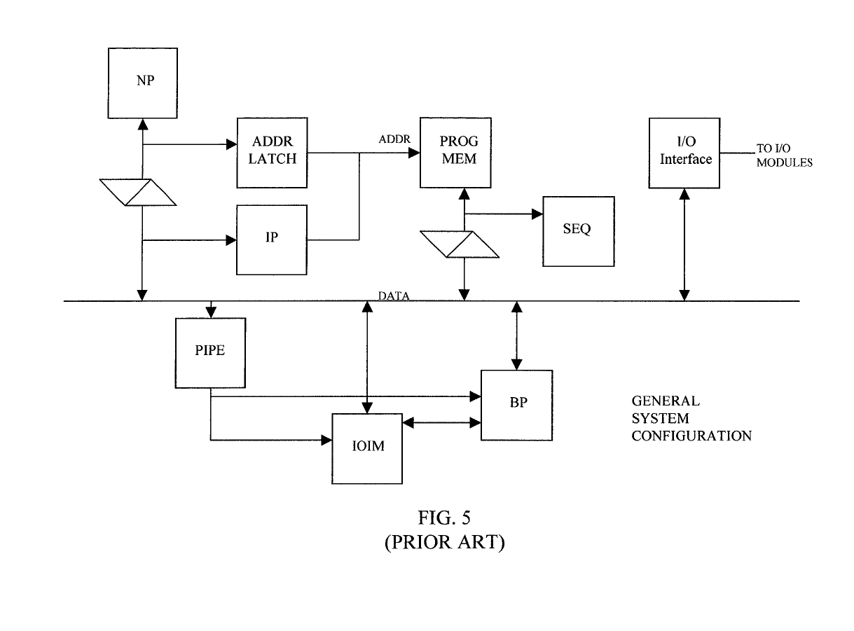

FIG. 6 is prior art and is a block diagram of coprocessor architecture using command storage unit.

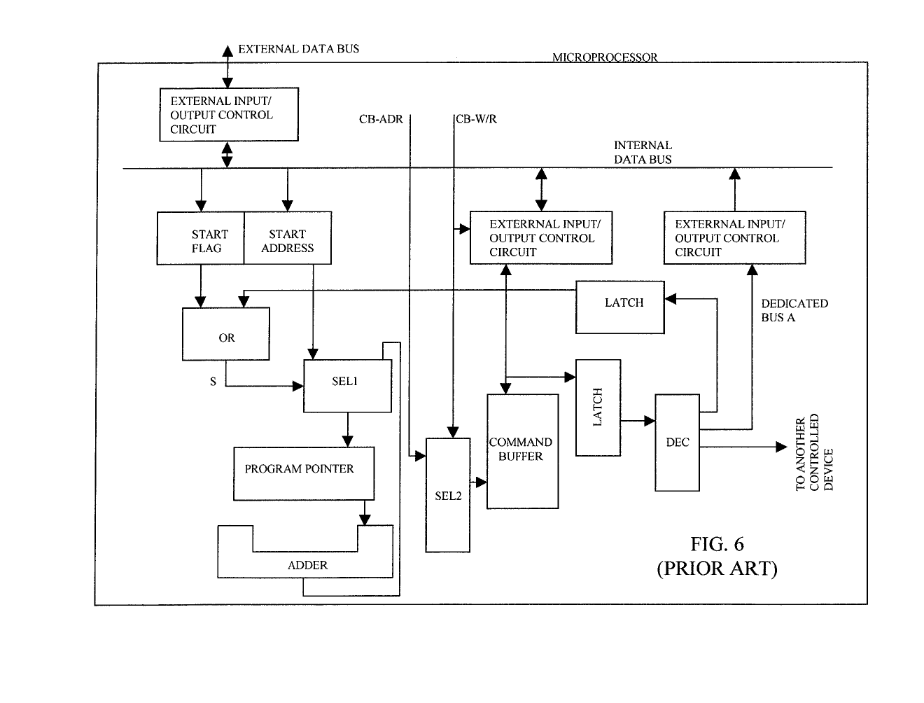

FIG. 7 is prior art and is a block diagram for a multi-processor architecture having a floating point unit.

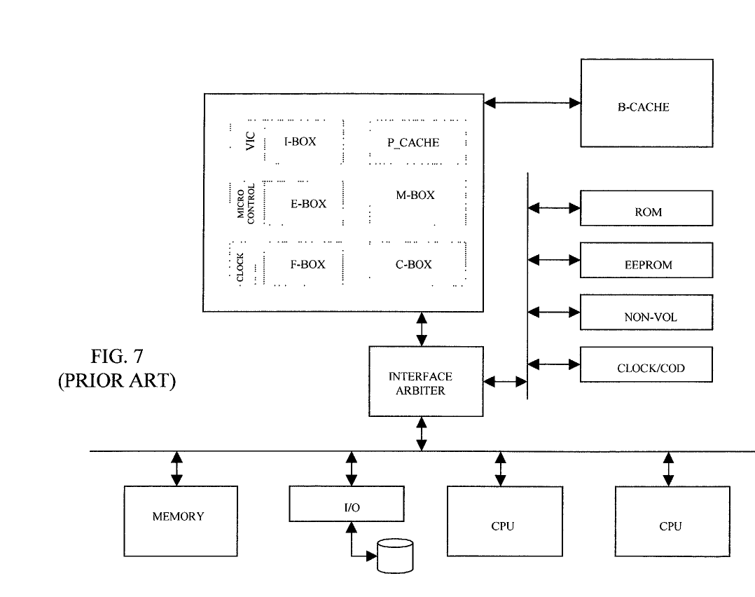

FIG. 8 is prior art and is a block diagram representation of task flow computer architecture.

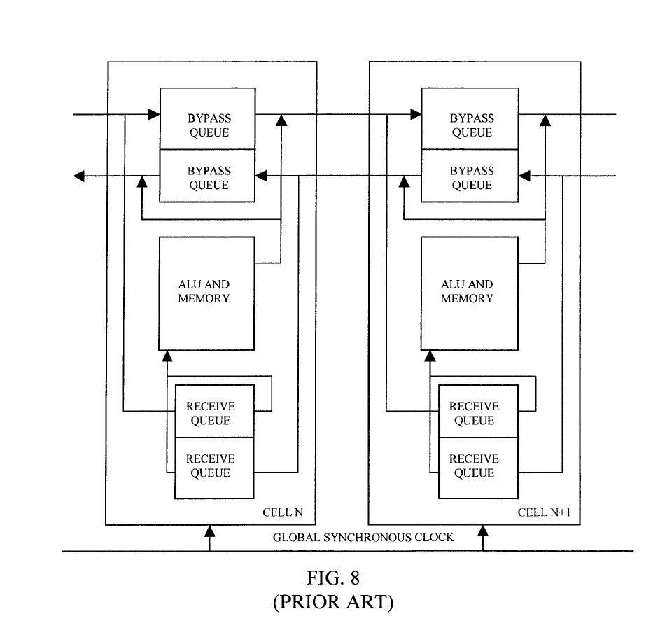

FIG. 9 is prior art and shows the operating phases of coprocessor system in SIEMENS Microcontroller Handbook.

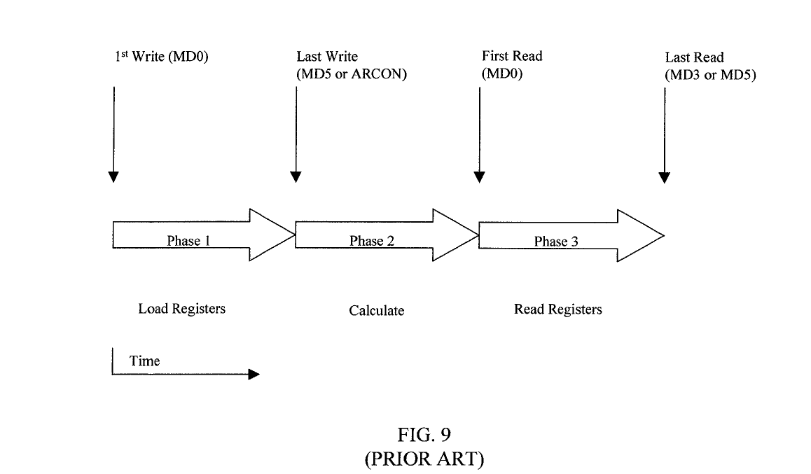

FIG. 10 is prior art and shows the operations and the time required to perform math computations as shown in SIEMENS Microcontroller Handbook.

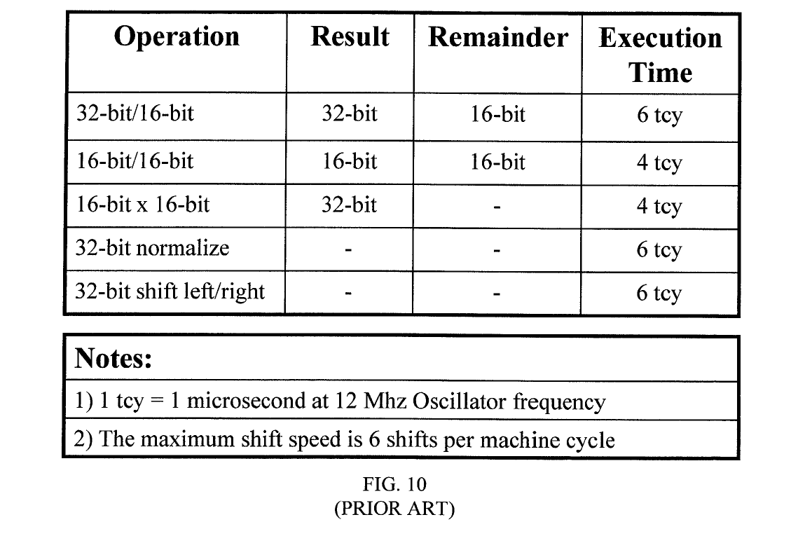

FIG. 11 is prior art and is a control register definition for coprocessor as shown in SIEMENS Microcontroller Handbook.

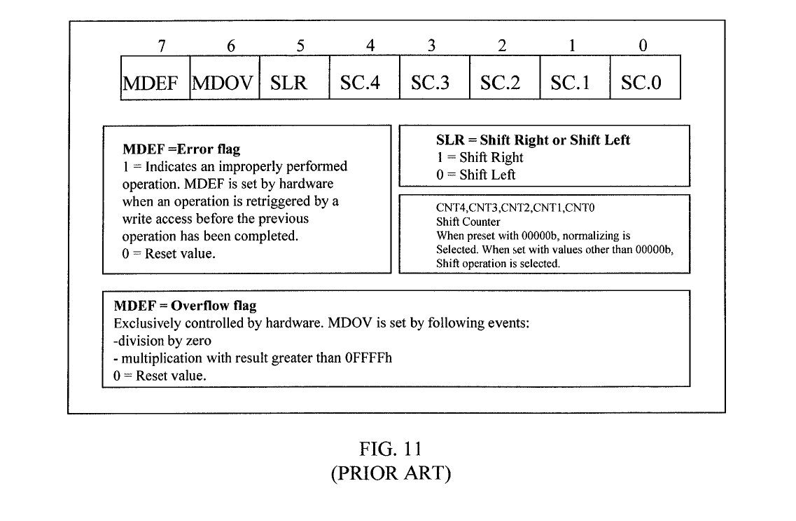

FIG. 12 is an architectural representation for processor coprocessor design using register file as an interface.

FIG. 13 is the description of the control register for coprocessor functions; and

FIG. 14 is the description of registers and the math function interface to registers.

### REFERENCE NUMERALS IN DRAWINGS

105 control processor

110 coprocessor

115 register file interface

120 control register architecture

125 M1M0 selection of math computation

130 selection of shift left or shift right

135 count register for shift or normalization

140 register file description

145 selection of registers

### DETAILED DESCRIPTION OF THE INVENTION

The accompanying drawings, that are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

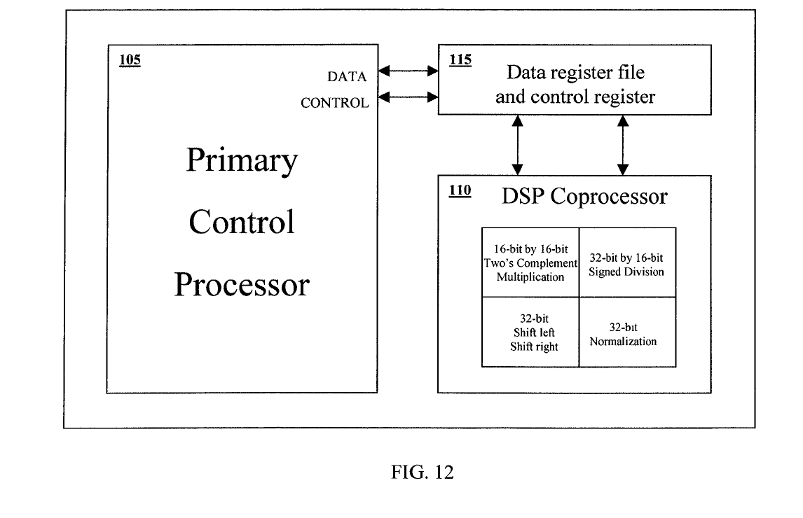

The DSP coprocessor math engine comprises of signed two's complement multiplication, signed division, shift left, shift right, and normalization functions. These are some of the most frequently used mathematical functions by digital signal processing algorithms. The block diagram of the control processor 105 coprocessor 110 architecture along with register file 115 interface is as shown in FIG. 12. The control processor has access to the register file to which it can write the source data operands. The results of the math computations are also available in the register file. The control processor accesses the register file to read the result of the coprocessor operation. The preferred embodiment is described with 8-bit control processor. In other implementations of this architecture, the control processor can be 16-bit processor or 32-bit processor and the bit widths of math computation could be of correspondingly higher magnitude.

Math functions can be achieved using combinational or synchronous design methods. Combinational logic design technique uses gates without any reference to clocks to implement the logic function. Synchronous logic uses clock to implement the logic functions. In synchronous logic design, the implementation can use the outputs at previous clock edge for computations at the current clock edge. Combinational design offers speed advantage. The penalty for using combinational design is that the number of gates required for implementation is significantly more compared to synchronous design. Synchronous designs on the other hand are gate size optimal but require more time than the time performance of combinational circuits. The relationship between Area (equivalent gates) and Multiplier width (bits) for combinational and synchronous implementation is not linear. As multiplier input width increases above 4 inputs, the combinational implementation are significantly larger compared to implementation in sequential logic. This analysis is as shown in the book HDL Chip Design (Douglas J Smith, Doone Publications, pages 286-287, which is hereby incorporated by reference). Gate size optimality also translates to lower integrated circuit size of the DSP engine that ultimately translates to lower manufacturing cost. The relationship between cost of integrated circuit and integrated circuit size (or die area) is discussed in detail in Computer Architecture —A Quantitative Approach (John L Hennessy and David A Patterson, 1996, Morgan Kaufmann Publishers, pages 10-12, which is hereby incorporated by reference). Higher gate count also corresponds to higher power consumption by the integrated circuit. Low power consumption is of extreme importance to portable electronic devices that use battery as a source of power.

There are several techniques, of various levels of complexity and speed, by which the division and multiplication function can be performed in logic design implementations for digital signal processors. The present invention uses synchronous multiplication techniques in which the time required to perform the computation is dependent on number of logic 0's and logic 1's in the multiplier. The signed division operation is also designed such that the time required for computation is dependent on logic 0's and logic 1's in the divisor. Achieving speed performance based on data dependency improves the system performance while performing DSP computations. The architecture in this invention is able to achieve higher performance and throughput for math intensive DSP computations and at the same time achieve the benefits of synchronous logic design techniques by making the design implementation as small as possible.

Cost of control processors is of extreme importance to system designers who are implementing systems to be used in automotive, industrial control processes, portable systems like smart cards, etc. The present invention that provides superior DSP speed performance at lower cost can enhance the capability of various electronic systems. DSP applications that are not extremely time critical can use low cost DSP computing techniques to achieve the system performance using this invention.

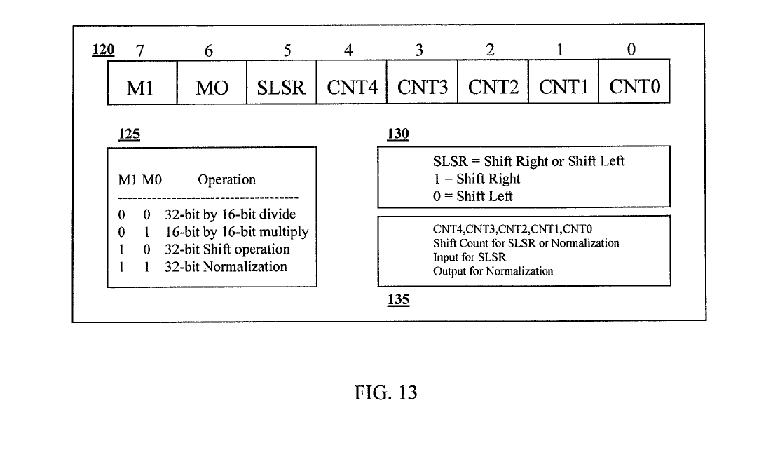

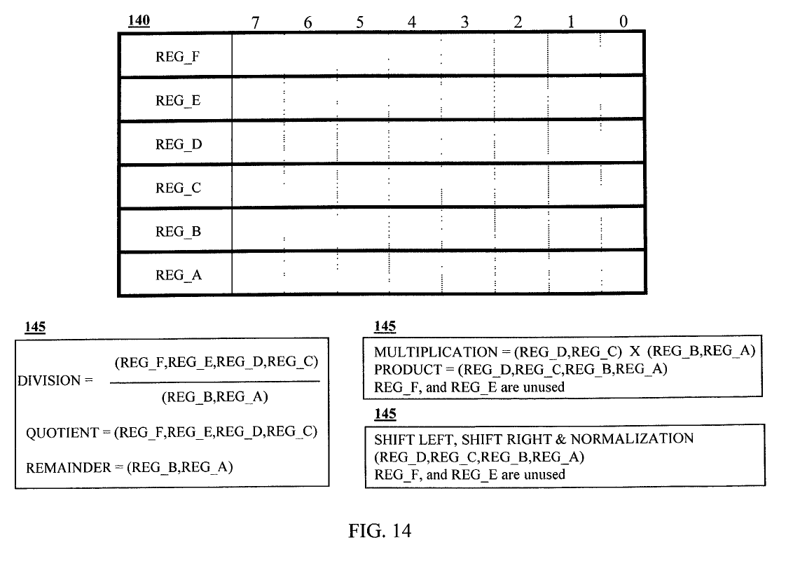

FIG. 13 contains details of the control register 120 for implementing the coprocessor functions. The binary value in the location of M1 and M0 indicate what coprocessor function is being requested by the processor. Value of 00 in M1 M0 125 corresponds to 32-bit by 16-bit signed division operation. The source and destination registers for source values and resultant values are as indicated in FIG. 14. Note that the source values are contained in register F through register A. The output values are also contained in register F through register A 140. The details of resultant are also indicated in FIG. 14. The value of 01 in M1M0 selects signed two's complement 16-bit by 16-bit multiplication operation. Two's complement multiplication is the most useful mathematical operation when implementing digital signal processing algorithms. Implementing filters and compression techniques becomes simplified with the availability of hardware multipliers. The value of 10 in M1M0 selects the 32-bit shift left or shift right operation. Shift left is accomplished when bit 5 130 in the control register is at logic 0. Shift right is accomplished when bit 5 in the control register is at logic 1. The value of 11 in M1M0 selects the 32-bit normalization operation. The normalization process takes the input binary number and does rotation to make the most significant bit (MSB) of that number to be at logic 1.

The bits corresponding to CNT4, CNT3, CNT2, CNT1, and CNT0 135 are used as inputs to specify the shift count during the 32-bit shift left or 32-bit shift right operation. The same bits CNT4, CNT3, CNT2, CNT1, and CNT0 are outputs during 32-bit normalization process. They indicate the number of shifts required to achieve normalization of a 32-bit number. A 5-bit binary value in CNT4, CNT3, CNT2, CNT1, and CNT0 can range from 00000 to 11111 that corresponds to 0 to 31 in decimal number representation.

FIG. 14 contains specific details on the register file architecture that acts as the primary interface between the processor and the coprocessor.

The process to perform a math operation would be to start writing to the register file with the data operands. The data operand registers are selected based on the type of computation that the designer wants done by the coprocessor. The selection of registers is as shown in FIG. 14 145. With the exception of signed division operation, all math computations use the 32-bit interface comprising of REG_D, REG_C, REG_B, and REG_A. The outputs of these computations are also available in the same register set. This scheme simplifies the design environment if one math computation is followed by another math computation and if the result of the current computation is used by the next computation. The write to the control register with correct values of M1M0, SLSR (if shift operation), and CNT4, CNT3, CNT2, CNT1, CNT0 (if shift operation) triggers the start of computation. The computing time for signed division, multiplication, shift left, shift right, and normalization is data dependent. For example, a normalization of 32-bit value corresponding to 0000_{—}0000_{—}0000_{—}0000_{—}0000_{—}0000_{—}0000_{—}1000 will require 28 left shifts. A normalization of 32-bit value corresponding to 000_{—}1100_{—}0000_{—}0000_{—}0000_{—}0000_{—}0000_{—}1000 will require only 4 left shifts. Time required to perform 28 left shifts is considerably more compared to performing 4 left shifts. In synchronous design methodology, each left shift operations corresponds to a clock cycle. Similarly, the time range is between (MultiplierWidth−1) to ((MultiplierWidth−1)×2) when multipliers are implemented using synchronous design techniques. The time to perform a signed division operation is also dependent on logic 1's and logic 0's in the divisor. For the shift operation, the time to perform the shift operation is dependent on the number of shifts requested by the designer. This number can range from 0 to 31 and is specified by CNT4, CNT3, CNT2, CNT1, and CNT0 value.

The architecture described uses synchronous logic design techniques to save logic gates. The design ends up using more time for doing the computations compared to the timings that could be achieved using combinational design method. As indicated previously, the computing times are different depending on the data when using synchronous design. The architecture uses a control protocol indicating to the control processor that the requested math computation is finished as soon as it is done with the computation. A logic state machine within the register file and control register block keeps track of computation completion. With this architecture technique, the control processor can fetch the result of math computation as soon as the operation is completed. This is a very significant system design advantage as opposed to waiting for a fixed amount of time before attempting to fetch the result. The fixed amount of time used in prior art always corresponds to the worst-case timing for the computation.

In algorithms where math computations are requested on a very frequent basis (as in DSP algorithms), waiting for a fixed amount of time can make the system design difficult to implement.

The current industry trend is also to implement remote diagnostics in products like refrigerators, washers, thermostats, sprinklers, water heaters, air conditioners, vending machines, security systems, medical devices and a host of other products. These applications will most likely be implemented by low-end control processor integrated circuit that can provide high end processing capability in the form of math computations, data connectivity, and data transfer systems. Such mass produced systems are cost sensitive and will have a need for digital signal processing in control processors. A detailed description of future control processor architecture applications is discussed in the article titled “Internet connectivity energizes 8-bit MCUs”, EE Times, Apr. 16, 2001, Charles J. Murray, page 22, which is hereby incorporated by reference).

The preferred embodiment was described in the context of 8-bit control processor and the DSP math engine comprising of 16-bit by 16-bit signed two's complement multiplication, 32-bit by 16-bit divide, 32-bit shift left and shift right, and 32-bit normalization functions. Another embodiment of this invention could include 32-bit control processor in which the coprocessor performs 32-bit by 32-bit signed two's complement multiplication, 64-bit by 32-bit signed division, 64-bit shift left and shift right, and 64-bit normalization.

The preceding examples can be repeated with similar success by substituting the generically or specifically described components and operating conditions of this invention for those used in the preceding examples. Although the invention has been described in detail with particular reference to these preferred embodiments, other embodiments can achieve similar results. Variations and modifications of the present invention will be obvious to those skilled in the art and it is intended to cover all such modifications and equivalents. The entire disclosures of all references, applications, patents, and publications cited above, are hereby incorporated by reference.

### CONCLUSION, RAMIFICATIONS, AND SCOPE OF INVENTION

Accordingly, the reader will see that the system designer with costand performance in mind can use this invention comprising of synchronous logic digital signal processor coprocessor to design low cost and high performance systems. The control processor architecture in combination with DSP coprocessor which implements high performance DSP computations using synchronous logic design techniques can be used in systems that previously used specialized digital signal processors. The technique by which the control processor uses data dependency and variable time to perform math computations will implement the digital signal processing algorithms efficiently. The interface described uses the existing instruction set preventing design of specialized DSP instructions. Since no new instructions are implemented, the processor coprocessor architecture leverages the use of existing software development infrastructure and expertise.

We claim:

1. A method for implementing coprocessor architecture in control processors using synchronous logic design technique to achieve digital signal processing capability, said method comprising the steps of:
implementing signed two's complement multiplication function; and
implementing divide function; and
implementing shift left and shift right function; and
implementing normalization function.

2. A method of implementing coprocessor architecture using register file as the interface for selecting the desired math computation.

3. A method of implementing coprocessor architecture using source data dependency to compute the time duration required to perform the math computation.
